(19) United States
(12) Patent Application Publication
(10) Pub. No.: US 2019/0032420 A1
(43) Pub. Date: Jan. 31, 2019

(54) WELL CASING AND WELL CASING SYSTEM AND METHOD

(71) Applicant: STRADA DESIGN LIMITED, St. Helier (JE)

(72) Inventors: Ian Speer, Gooseberry Hill (AU); Warren Strange, St Helier (JE)

(21) Appl. No.: 15/748,794

(22) PCT Filed: Aug. 1, 2016
(86) PCT No.: PCT/AU2016/050692

§ 371 Date: Jan. 30, 2018

(30) Foreign Application Priority Data
Jul. 30, 2015 (AU) 2015903040

(51) Int. Cl. E21B 17/00; E21B 17/10; F16L 9/00; F16L 9/14

(52) U.S. Cl. CPC E21B 17/00; F16L 9/14; F16L 9/006; E21B 17/1014

(57) ABSTRACT

A well casing system (10) for installation in a well (12) is drilled into the ground (14) comprises a number of separate lengths of well casing (Cn). Each length of well casing (Cn) comprises a single continuous length of rigid composite material pipe or tube.

### TECHNICAL FIELD

A well casing is disclosed. The well casing may be applied to any type of well such as for example an oil and gas well; a geothermal well or a water well. Also disclosed is a well casing structure for a well, a method of casing a well and a well casing system.

### BACKGROUND ART

The present background is described in the context of an oil and gas well. A well may be several kilometres deep traversing through many different types of geological layers. Prior to the well being able to produce oil or gas a well casing must be installed. The casing performs many different functions. These functions include preventing the cave-in of the well; isolating different geological structures that may conduct different pressures or fluids into the well; sealing off and preventing loss of drilling fluid from the well or contamination of the production fluid.

A well casing usually comprises a string of pipes or tubes connected axially end to end. However to case a well a number of well casings of different diameter are required. For example an oil well may contain in order of progressively decreasing diameter but increasing length, a conductor casing, a surface casing, an intermediate casing and a production casing.

When drilling a well the initial length of the well is drilled at the largest diameter. When the depth reaches a planned point or when difficult ground conditions are encountered the first and largest diameter casing is placed in the well and cemented in place. Once that casing has been installed in the well and cemented in place drilling commences inside of that casing at a smaller diameter. At some point dictated either by the geological conditions or the well design, drilling is suspended and another casing is installed and cemented in place. This process of drilling at progressively smaller diameters and casing the well continues until the well reaches the desired depth.

Each casing comprises a string of steel casing pipes or tubes which are lowered into the well by the same drill rig used for drilling the well. The string must be assembled one pipe or tube at a time at the rig. One type of well casing is formed with pin and box threads at opposite ends to enable screw jointing of the pipes/tubes. This screw jointed casing takes time to assemble and also the joint has a larger diameter than the remainder of the pipe which means that the reduction in the possible internal diameter is greater when using screwed casing. Also screwed casing can be subject to corrosion at the joints.

Instead of screw jointed casing, welded casing is also known and used. Welded casing is much slower to install and requires hot work around the wellhead which is inherently dangerous. Welded casing is thinner when installed as it does not require additional material thickness to accommodate a screw thread.

When casing is welded the strength and reliability of the weld is a function of the welders's skill, the weld preparation, the welding process used as well as the inspection techniques employed after each weld. To achieve 100% weld strength is very expensive in the field hence the joint must be overdesigned or a screwed casing has to be used as the screw joint is well understood, notwithstanding the additional thickness is a substantial engineering penalty.

Other proprietary types of tube/pipe connections are also available. These all require assembly and may introduce limitation on internal bore or external well diameter and/or mechanical strength.

Well casing is often provided in standard lengths for example 10 m. Thus when drill a well to any reasonable depth such as say 3000 metres or more there is a very significant issue with transporting and handling the casing as well as storing the casing on site.

As the well deepens the weight of the casing being lowered increases which will dictate the size of the rig needed. Also the thickness of the casing has to be increased to provide adequate tensile strength to ensure the casing does not simply pull itself apart.

The above description of the background art is not intended to limit the application of the well casing, well casing structure, well casing system and method of casing a well as disclosed herein to an oil and gas well. For example the disclosed well casing, well casing structure, well casing system and method of casing a well may also be used for geothermal wells or water wells. The wells may be land based or subsea.

### SUMMARY OF THE DISCLOSURE

In broad terms in a first aspect there is disclosed a rigid well casing made from a composite material. The casing may be made on site as a single piece, i.e. continuous, pipe or tube of any desired length with no joins. The casing may also be made to any diameter. The continuous well casing may also be made of any desired wall thickness and as a consequence different pressure ratings. This also enables the initial larger diameter continuous casings to be made thinner than subsequent casings due to the decreased requirement for tensile strength at the lower depths. This represents a significant saving in materials and also requires a smaller rig to be used to place the casing into the well.

The composite material may include but is not limited to fibre reinforced polymer being a composite material made from a polymer matrix reinforced with fibres. The fibres may include but are not limited to carbon, glass and aramid. The polymer may be in the form of epoxy, polyester thermosetting plastic and phenyle formaldehyde resins.

The orientation of the fibres in the composite material may be varied to optimise the properties of the casing for a particular well or conditions at hand. For example fibres in a fibre mat may have a bias of: circumferential strands, spirally wound strands and axially extending strands.

In one aspect there is disclosed a well casing comprising a continuous length of composite material pipe.

In one embodiment the pipe has a constant wall thickness.

In one embodiment the pipe has a wall thickness that varies along an axial direction of the pipe.

In one embodiment the wall thickness increases from one end of the pipe to an opposite end of the pipe.

In one embodiment the wall thickness increases in a stepped manner.

In one embodiment the wall thickness increases in a progressive manner.

In one embodiment the pipe has a constant inner diameter.

In one embodiment the pipe has an outer circumferential surface is textured or profiled in a manner to promote adhesion to cementitious material.

In one embodiment the well comprises one more integrally formed centralising mechanisms formed about the pipe and capable of centralising the casing within a well

In a second aspect there is disclosed a method of casing a well comprising running a casing in accordance with the first aspect into the well.

In one embodiment running the casing into well until the casing reaches a bottom of the well.

In one embodiment the method comprises cutting the casing at or near a mouth of the well subsequent to the casing being run in the bottom of the well.

In one embodiment running the casing comprises running the casing along an arcuate path from a substantially horizontal disposition when outside of the well to a substantially vertical disposition when the casing initially enters the well.

In one embodiment the method comprises forming the casing in situ near a well and laying the casing in an orientation such that an axis of the casing lies in a substantially horizontal plane.

In one embodiment the method comprises forming the casing continuously in an orientation where an axis of the casing is substantially vertical.

In one embodiment the method comprises supporting a casing forming unit on a rig used for drilling the well into which the casing is run.

In accordance with a third aspect there is disclosed a well casing structure comprising two or more continuous lengths of composite material pipe, each length of pipe having a different diameter, the lengths of pipe arranged co-axially wherein each pipe has an uphole end and a downhole end, the uphole end of each pipe lying substantially adjacent each other and wherein the downhole end of successively smaller diameter pipes lie at a depth that is deeper than that of an adjacent larger diameter pipe.

In a fourth aspect there is disclosed a well casing system comprising a well casing fabrication system capable of forming a continuous length of composite material pipe; and,

a case feeding system capable of feeding the casing to a location where the location is run into the well.

In one embodiment the well casing fabrication system is arranged to form the casing in an orientation such that an axis of the casing lies in a substantially horizontal plane.

In one embodiment the well casing fabrication system is arranged to form the casing in an orientation such that an axis of the casing lies in a vertical plane.

In a fifth aspect there is disclosed a cased well comprising a well cased with a casing in accordance with the first aspect of the disclosed well casing.

### DESCRIPTION OF THE DRAWINGS

Notwithstanding any other forms that may fall within the scope of the well casing, the method of casing a well, the well casing structure and the well casing system as set forth in the Summary, specific embodiments will now be described by way of example only with reference to the accompanying drawings in which:

FIG. 1 us a schematic representing of an embodiment of the disclosed well casing system composed of a plurality of the disclosed well casings installed in a well;

FIG. 2 is a schematic representation of an embodiment of a well casing system which may be used to install an embodiment of the disclosed well casing;

FIG. 3a is an end view of a second embodiment of the disclosed well casing;

FIG. 3b is perspective view of the second embodiment of the well casing shown in FIG. 3a;

FIG. 4 is a schematic representation of a third embodiment of a well casing system incorporating a centralizing mechanism;

FIG. 5a is perspective view of a fourth embodiment of the well casing; and

FIG. 5b is perspective view of a fifth embodiment of the well casing.

### DETAILED DESCRIPTION OF PREFERRED EMBODIMENTS

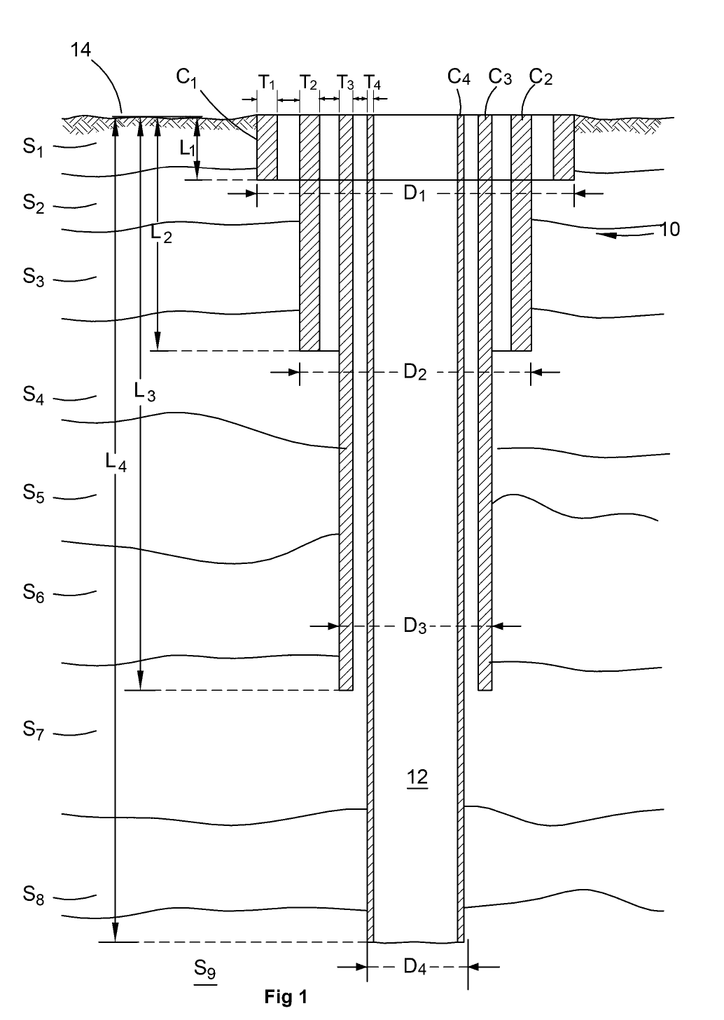

FIG. 1 depicts an embodiment of the disclosed well casing system 10 installed in a well 12. The well 12 is drilled into the ground 14 which is composed of a number of different layers of strata S1-S9. The nature of the strata is not important to the embodiments of the described well casing, well casing system, well casing structure and method of casing a well.

The well casing system 10 comprises a number of separate lengths of well casing C1, C2, C3 and C4 (hereinafter referred to in general as “well casing C” or “casing C”).

Each of the casings C1-C4 comprises a single continuous length of composite material pipe or tube. Each casing has a wall thickness Ti; a length Li and a diameter Di where in this instance i=1, 2, 3 or 4. For example the well casing C1 has a thickness T1, a length L1 and a diameter D1.

In the illustrated well casing system 10 the casings are arranged so that the outermost casing C1 has the largest diameter D1 and the shortest length L1. The inner next casing C2 has a thickness T2, a length L2 and a diameter D2. The next smaller diameter casing C3 has a wall thickness T3 and a length L3. The inner next casing C4 has the smaller diameter D4, a wall thickness T4 and a length L4. As the diameter Di decreases the wall thickness Ti also decreases but the length Li increases.

As illustrated in FIG. 1 embodiments of the well casing C can be made to any desired or required wall thickness Ti, diameter Di and length Li. By way of non-limiting example the casing C1 may have a thickness T1 of 1 cm, a diameter D1 of 100 cm and a length L1 of 10 m. In comparison the casing C4 may have a wall thickness T4 of 0.3 cm, a diameter D4 of 15 cm and a length L4 of 4000 m.

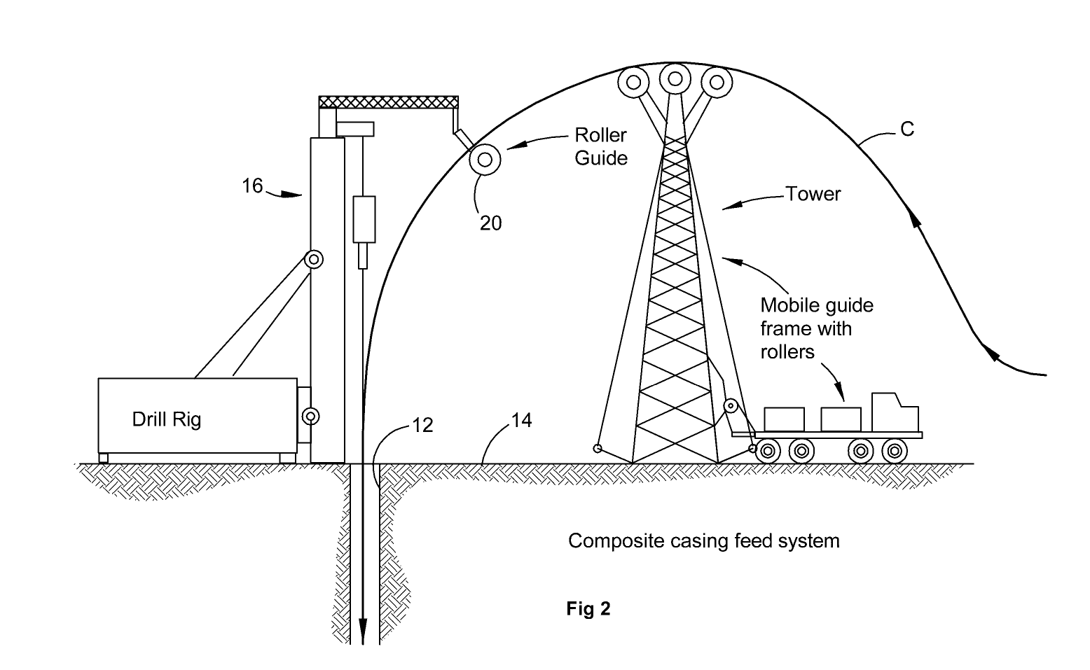

With reference to FIG. 2, the casing C may be manufactured in situ (i.e. on site) near a drill rig 16 used to form the well 12. A well casing fabrication system (not shown) may be used to manufacture lengths of the casing C. The well casing fabrication system can be arranged to form the casing in an orientation such that a longitudinal axis of the casing lies in a substantially horizontal plane. That is, the well casing fabrication system forms the casing as a continuous pipe along the ground or on a supporting structure on the ground. The casing as described beforehand may be thousands of meters long. This is simply laid out in a line near the drill rig 16.

In FIG. 2 the casing C which has been formed and laid along the ground 14 is fed into the well 12 via a mobile guide frame 18 and a roller arrangement 20 supported on the rig 16. Thus for example to run a 4000 meter long casing C into the well 12, a downhole or leading end of the casing is picked up from the ground run over the tower 18 and through the roller 20 and fed into the well 12. The tower 18 is arranged to have a length or height which is greater than the maximum bend radius of the conduit C to ensure that the casing C does not crack or break during running into the well 12.

Various mechanisms may be used to control the rate of feeding of the casing C into the well 12 including to brake or halt the running at any point in time. It is possible to manufacture the length of the casing C to exactly match the depth of the well into which it is run. Alternately if desired the casing C may be made with additional length and simply cut at or near the surface 14 once the casing C has reached the bottom of the well 12.

During manufacture of the casing C fibres used in the casing may be orientated in a particular way or indeed different ways for different lengths of casing to provide various required physical characteristics particularly tensile strength and hoop stress requirements. For example the fibres in a fibre mat may be arranged as a regular weave of mutually perpendicular weft and warp to produce a particular physical characteristic. However alternate fibres may be arranged in the same base structure weave but with additional or different fibres extending for example in an axial direction to provide increased tensile strength or in a circumferential direction to provide increased hoop stress capabilities.

The casing C is manufactured as a rigid casing to a designed inner and outer diameter. This can be varied to meet the well design requirements. Although the casing C is rigid, by being made of fibre composite materials the casing C nonetheless has a degree of flexibility to enable bending over a radius such as for example when being installed utilising the system shown in FIG. 2. Thus the rigidity of the casing C is manifested by the casing C having a wall which in any radial plane has a substantially fixed inner diameter and outer diameter. This is to be contrast with collapsible hose like pipe or casing that may be flattened and rolled on a reel then unwound and expanded or inflated to open up to its maximum inner diameter.

One suitable manufacturing process the casing C is made by a moulding process. In another suitable manufacturing process the casing is made as a continuous extrusion. In both of these manufacturing methods in a radial plane the casing has a one-piece continuous annual wall.

Additionally: various sensors for example temperature sensors, pressure sensors, fluid flow sensors, fluid analysis sensors; monitoring devices; power cables; communication cables; and other electronic equipment may be embedded in the casing C during manufacture. The power and communication cables can be run from a downhole end of the casing to the surface. This facilitates the ability to monitor at least some well conditions without running a survey tool down the well.

Further, the casing C may be formed with its outer surface textured to assist or otherwise aid in adhering to cementitious products. This may be arranged for example by providing the outer surface of the casing C with a prescribed or desired roughness. This is to be contrast with for example an inner surface of the casing C which ideally should be as smooth as possible.

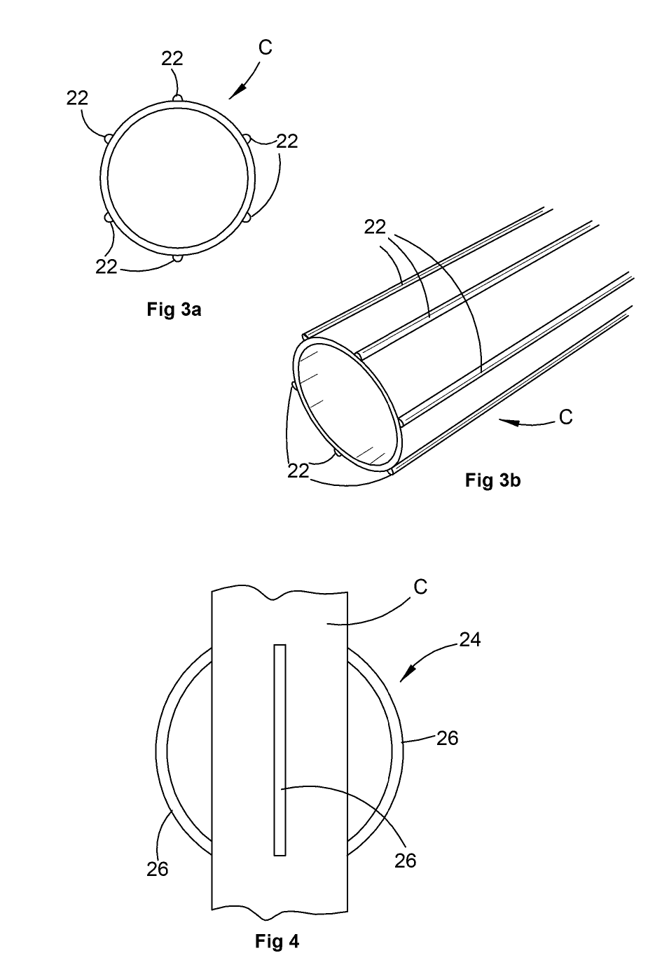

In addition or as an alternative to the surface texturing, the casing C may also be provided with specific profiles to again assist in binding or adhering to cementitious products. For example longitudinal ribs or fins may be formed integrally with the casing C. This is shown for example in FIGS. 3a and 3b. These Figures depict a casing C provided with a plurality of longitudinally extending ribs 22.

Additionally, as shown in FIG. 4, centralising mechanisms 24 may be formed integrally with the casing C. Centralising mechanisms 24 may be placed at any locations spaced along the length of the casing C. In this embodiment the centralising structure 24 comprises a number of arcuate rigid but flexible bands 26 which are bowed outwardly from the outer circumferential surface of the casing C. The bands 26 of the centralising mechanism 24 are arranged so as to engage the surface of the well and substantially locate the casing C centrally of the well. This then forms an annulus between the outer circumferential surface of the casing C and the wall of the well. This annulus may then be filled with cement or may be arranged to seat a packer or seal.

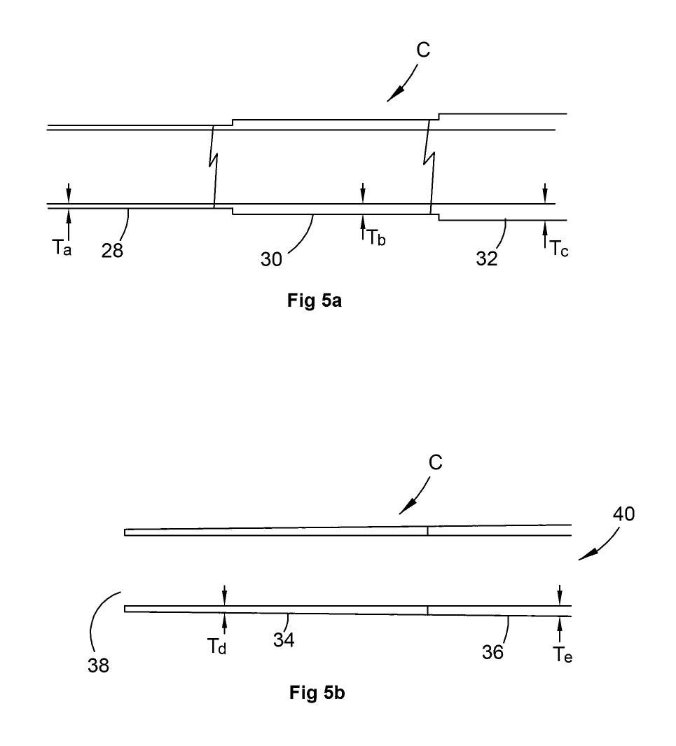

Whilst specific embodiments have been described it should be appreciated that the disclosed well casing, well casing system, well casing structure and method of casing a well may be embodied in many other forms. For example, each of the casings C1-C4 described above have a constant wall thickness Ti. However the casing C may be made with sections of different or variable thickness T. This is shown for example in FIGS. 5a and 5b. FIG. 5a depicts a casing C having three contiguous sections 28, 30 and 32. The section 28 has a wall thickness Ta, the section 30 has a wall thickness Tb and the section 32 has a wall thickness Tc. In this pipe Tc>Tb>Ta. There is a stepped increase in the thickness from Ta to Tb to Tc. The sections 28, 30 and 32 may be hundreds or thousands of meters long.

FIG. 5b shows an alternate arrangement where a casing C has a section 34 and a contiguous section 36. The section 34 has a progressively increasing thickness Td from a downhole end 38 of the casing C toward an uphole end 40. At a transition point between the sections 36 and 34 Td=Te. The section 36 remains with a wall thickness Te to the uphole end 40.

In one embodiment a single continuous length of casing can be made with progressive or stepped variation in one, or two or more, of: (a) outer diameter; (b) inner diameter; and (c) wall thickness. In comparison with prior art steel casing this avoids running different stages of steel casing into the well.

In a further variation rather than forming the well casing C in a horizontal disposition where it is formed and laid horizontally on the ground 14 it is envisaged that the casing can be formed in a vertical orientation for example by supporting a case forming system on the drill rig. In that event the casing simply requires to be lowered or run directly into the well 12. In this instance there is no requirement to cause the casing C to traverse an arcuate path and bend over the tower 18 when being run into the well 12. A benefit of this is that the casing C can be made with a greater tensile strength as it is not required to bend or flex the casing C in order to install it into the well 12.

Embodiments the casing made be made as a single piece for the entire length of a well or portion of a well. However it also possible to manufacture shorter lengths of the casing and join them together prior to, or when, being placed in the well. For example instead manufacturing a single 1500 m length of casing for a corresponding length of well, three separate 500 m long casings could be manufactured and jointed end to end by laying up of composite material at adjacent ends of the separate lengths. Other circumstances which may give rise the manufacture of the continuous well casing in lengths shorter than a full depth of a well or well portion include: accidental on-site damage (for example being fractured due to a heavy vehicle impact); or, loss of power resulting in incomplete manufacture of a designed length. In yet another variation particular reference to FIGS. 3a and 3b, the ribs 22 may be in the form of pipes embedded in the wall of the casing C which may also be provided with openings to allow injection of fluids into the well.

In the claims which follow, and in the preceding description, except where the context requires otherwise due to express language or necessary implication, the word “comprise” and variations such as “comprises” or “comprising” are used in an inclusive sense, ie to specify the presence of the stated features but not to preclude the presence or addition of further features in various embodiments of the well casing, well casing system, well casing structure and method of casing a well as disclosed herein.

The claims defining the invention are as follows:

1. A well casing comprising: a continuous length of rigid composite material pipe.

2. The well casing according to claim 1 wherein the pipe has a constant wall thickness.

3. The well casing according to claim 1 wherein the pipe has a wall thickness that varies along an axial direction of the pipe.

4. The well casing according to claim 3 wherein the wall thickness increases from one end of the pipe to an opposite end of the pipe.

5. The well casing according to claim 4 wherein the wall thickness increases in a stepped manner.

6. The well casing according to claim 4 wherein the wall thickness increases in a progressive manner.

7. The well casing according to any one of claims 2 to 6 wherein the pipe has a constant inner diameter.

8. The well casing according to any one of claims 2 to 7 wherein the pipe has an outer circumferential surface is textured or profiled in a manner to promote adhesion to cementitious material.

9. The well casing according to any one of claims 2 to 8 comprising one more integrally formed centralising mechanisms formed about the pipe and capable of centralising the casing within a well.

10. A method of casing a well comprising: running a casing in accordance with any one of claims 1 to 9 into the well.

11. The method according to claim 10 wherein running the casing comprises running the casing into well until the casing reaches a bottom of the well.

12. The method according to claim 11 comprising cutting the casing at or near a mouth of the well subsequent to the casing being run in the bottom of the well.

13. The method according to any one of claims 10 to 12 wherein running the casing comprises running the casing along an arcuate path from a substantially horizontal disposition when outside of the well to a substantially vertical disposition when the casing initially enters the well.

14. The method according to claim 13 comprising forming the casing in situ near a well and laying the casing in an orientation such that an axis of the casing lies in a substantially horizontal plane.

15. The method according to any one of claims 10 to 12 comprising forming the casing continuously in an orientation where an axis of the casing is substantially vertical.

16. The method according to claim 15 comprising supporting a casing forming unit on a rig used for drilling the well into which the casing is run.

17. A method of casing a well comprising: running a continuous length of composite material rigid pipe into the well.

18. A well casing structure comprising two or more continuous lengths of composite material rigid pipe, each length of pipe having a different diameter, the lengths of pipe arranged coaxially wherein each pipe has an up hole end and a down hole end, the up hole end of each pipe lying substantially adjacent each other and wherein the down hole end of successively smaller diameter pipes lie deeper than that of an adjacent larger diameter pipe.

19. A well casing structure comprising two or more lengths of casing according to any one of claims 1-9, each length of casing having a different diameter, the lengths of casing arranged coaxially wherein each case has an up hole end and a down hole end, the up hole ends of each case lying substantially adjacent each other and wherein the down hole end of successively smaller diameter casings lie at depth that deeper than of an adjacent larger diameter casing.

20. A well casing system comprising:
a well casing fabrication system capable of forming a continuous length of composite material rigid pipe; and
a case feeding system capable of feeding the casing to a location where the casing is run into the well.

21. The well casing system according to claim 20 wherein the well casing fabrication system is arranged to form the casing in an orientation such that an axis of the casing lies in a substantially horizontal plane.

22. The well casing system according to claim 20 wherein the well casing fabrication system is arranged to form the casing in an orientation such that an axis of the casing lies in a vertical plane.

23. A cased well comprising a well cased with a casing in accordance with any one of claims 1-9.

24. A cased well comprising a well and a well casing structure according to claim 19 or 20 installed in the well.
